(19) United States
(12) Patent Application Publication
(10) Pub. No.: US 2007/0098852 A1
(43) Pub. Date: May 3, 2007

(54) Candy attachment for a writing implement

(75) Inventor: Dana Ellis, West Orange, NJ (US)

Correspondence Address: MCCARTER & ENGLISH, LLP, FOUR GATEWAY CENTER, 100 MULBERRY STREET, NEWARK, NJ, 07102, US

(73) Assignee: Harde Company, LLC

(21) Appl. No.: 11/589,672

(22) Filed: Oct. 30, 2006

Related U.S. Application Data
(60) Provisional application No. 60/731,148, filed on Oct. 28, 2005.

(51) Int. Cl. A23G 3/00

(52) U.S. Cl. 426/90

(57) ABSTRACT

A candy attachment for a writing implement is provided. The attachment comprises a sleeve embedded within a candy (e.g., a hard or soft candy), wherein an end of writing implement can be inserted into the sleeve and frictionally engaged therewith to attach the candy to the writing implement. After the candy has been consumed, the sleeve can be removed from the writing implement and discarded.

### RELATED APPLICATIONS

The present application claims the benefit of U.S. Provisional Application Ser. No. 60/731,148 filed Oct. 28, 2005, the disclosure of which is expressly incorporated herein by reference in its entirety.

### BACKGROUND OF THE INVENTION

1. Field of the Invention

The present invention relates to a candy attachment for a writing implement. More particularly, the present invention relates to a candy attachment having an embedded sleeve which is attachable to an end of a pen, pencil, or other writing implement.

2. Background of the Invention

Children, and even adults, love candy. Almost everyone likes lollipops. It is well known that many people chew on pens or pencils. What would be desirable is to provide a candy for use on a pen, pencil, or other writing implement.

Various accessories for writing implements have, in the past, been provided, for attaching candy to an end of a pen or pencil. One example is a writing accessory having an elongate member with a hard candy disposed on one end of the elongate member and a connector disposed on an opposite end of the elongate member, exterior of the candy, wherein the connector is removably engageable with an end of a pen or pencil. However, such a design results in a large, extended, and unstable product that is difficult to write with when the candy is attached to a writing implement.

Accordingly, what would be desirable, but has not yet been provided, is a candy attachment for a writing implement that is easily replaceable, remains stable when attached to a writing implement, and includes a sleeve embedded in the candy for removably attaching the candy to the writing implement.

### SUMMARY OF THE INVENTION

The present invention relates to a candy attachment for a writing implement. The attachment comprises a sleeve embedded within a piece candy (e.g., a hard or soft candy). An end of a writing implement, such as a pen or pencil, is insertable into the sleeve and frictionally engageable therewith to removably attach the candy to the writing implement. When attached to the writing implement, the candy attachment remains stable during writing. After the candy has been consumed, the sleeve can be removed from the writing implement and discarded, and another candy attachment according to the present invention can be provided for attachment to the writing implement.

### BRIEF DESCRIPTION OF THE DRAWINGS

Other important objects and features of the invention will be apparent from the following Detailed Description of the Invention taken in connection with the accompanying drawings, in which:

FIG. 1 is a front view showing the candy attachment of the present invention, which is removably attachable to a writing implement.

FIG. 2 is a cross-sectional view of the candy attachment of the present invention, taken along the line 2-2 of FIG. 1, showing a sleeve recessed into the candy attachment.

FIG. 3 is another embodiment of the candy attachment shown in FIG. 2, in which the sleeve has first and second diameters.

FIG. 4 is another embodiment of the candy attachment shown in FIG. 1, wherein the configuration of the upper end of the recess is less tapered.

FIG. 5 is another embodiment of the candy attachment shown in FIG. 2, in which the sleeve tapers.

FIG. 6 is a perspective view of the candy attachment attached to a writing implement.

### DETAILED DESCRIPTION OF THE INVENTION

The present invention relates to a candy attachment for a writing implement comprising a sleeve embedded within a piece of candy (e.g., a hard or soft candy). The sleeve is frictionally engageable with an end of the writing implement to removably attach the candy to the writing implement.

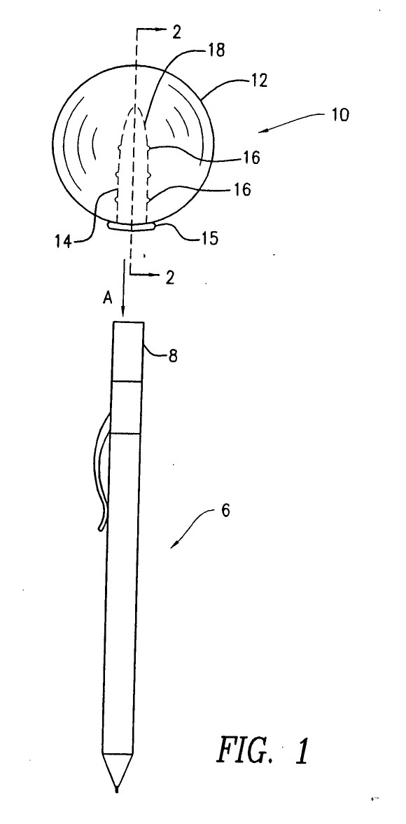

FIG. 1 is a front view showing the candy attachment of the present invention, indicated generally at 10. The attachment 10 comprises a sleeve 14 embedded in a candy 12. The candy 12 could be any desired hard or soft candy. The sleeve 14 is sized and shaped to receive an end 8 of a writing implement 6 (which could comprise any desired writing implement, such as a pen, pencil, marker, crayon, etc.) and frictionally engages the end 8 of the writing implement 6 when the end 8 is inserted into the sleeve 14 (as indicated by arrow A). When the candy attachment 10 is attached to the writing implement 6, the candy attachment 10 remains stable during writing. After consuming the candy 12, a user can remove the sleeve 14 from the writing implement and discard same. It should be noted that the candy 12 could be provided in any desired shape or configuration without departing from the spirit or scope or the present invention. The invention can be viewed as recessing a cover for a writing implement, e.g. a pen cap, into a candy for attachment of the candy to the writing implement, e.g. a pen.

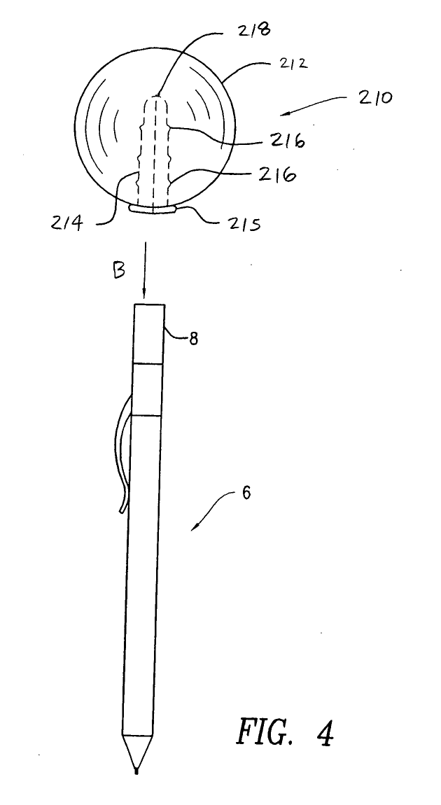

The sleeve 14 can include a rim 15 at a lower edge. The rim 15 is positioned on the exterior of the candy 12. The sleeve 14 can also include one or more ribs 16 extending circumferentially about the outside of the sleeve 14. These ribs 16, if present, serve to retain the sleeve 14 within candy 12. The sleeve 14 can also include a rounded apex 18 which can coact with an eraser on the end of a pencil (not shown), or the end of a pen, to frictionally engage the candy attachment thereon. The configuration of the apex 18 at the upper end of the sleeve 14 can be varied. As shown in FIGS. 1-3, the apex 18 of the sleeve 14 can be tapered, or as shown in FIG. 4, it can be more cylindrical, or it can have any other suitable shape. The apex 18 can be designed to best engage a particular shaped writing implement.

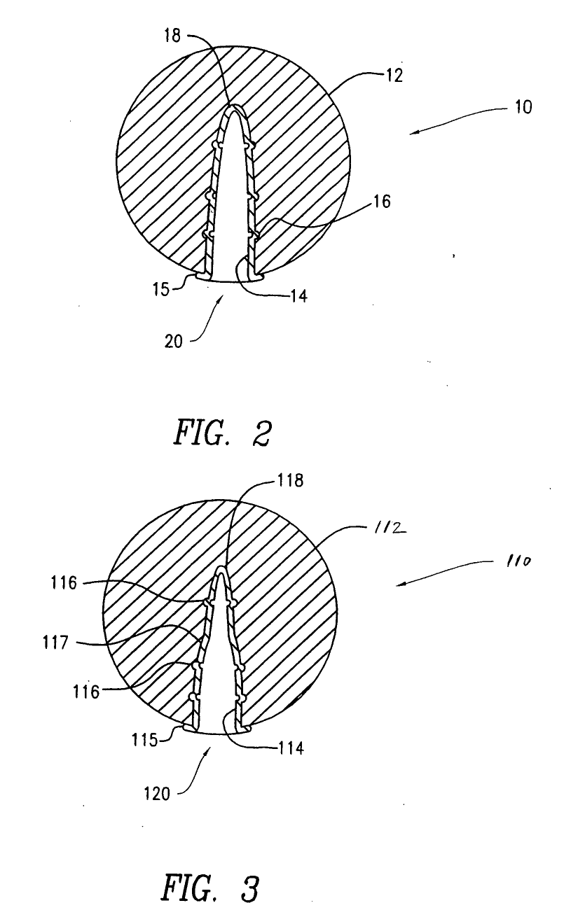

FIG. 2 is a cross-sectional view of the candy attachment 10 of the present invention, taken along the line 2-2 of FIG. 1. As can be seen, the sleeve 14 is embedded within the candy 12. The sleeve 14 includes an aperture 20 for receiving an end of a writing implement. It should be noted that the length of the sleeve 14 can be adjusted, but it is desirable that the sleeve 14 extends a sufficient distance into the candy 12 to provide for stable attachment of the candy 10 to the writing implement. Circumferential ribs 16 and rounded apex 18 can also be seen.

FIG. 3 shows another embodiment of the candy attachment of the present invention, indicated generally at 110 which includes a sleeve 114 having an opening 120. This sleeve 114 is embedded in a candy 112, and has areas with different diameters to accommodate different sized writing implements. Circumferential ribs 116 and rounded apex 118 could also be provided. A necked down area 117 is provided between the different diameters, and it is rounded so that it can frictionally engage an eraser on a pencil. A rim 115 can also be provided at a lower edge of the sleeve 114.

FIG. 4 shows another embodiment of the candy attachment of the present invention, indicated generally at 210. The candy attachment 210 is similar in construction to the candy attachment shown in FIG. 1, except that the sleeve 214 is generally cylindrical in shape and includes a nearly-cylindrical end 218. As with the embodiment shown in FIG. 1, the sleeve 214 is embedded in a candy 212, and could include a plurality of ribs 216 extending circumferentially from the sleeve 214 to engage the candy 212. The end 8 of the writing implement 6 can be inserted into the sleeve 214, as shown by arrow B.

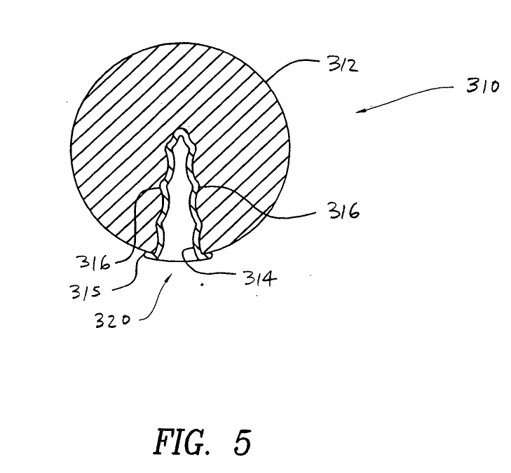

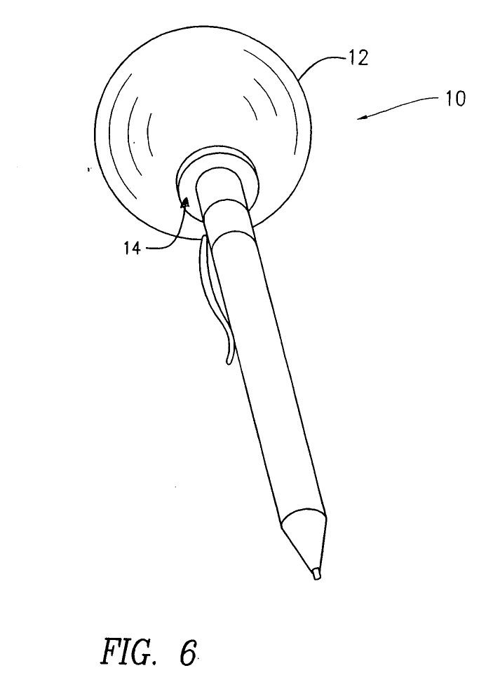

FIG. 5 shows another embodiment of the candy attachment of the present invention, indicated generally at 310, which includes a sleeve 314 embedded in a candy 312. The sleeve 314 includes an opening 320 and a plurality of ribs 316. The sleeve 314 tapers from a wider open end to a smaller diameter inner end to accept and frictionally engage writing implements of different sizes. A rim 315 could also be provided on the sleeve 314.

FIG. 6 is a perspective view showing the candy attachment 10 on a writing implement. As can be seen, the sleeve 14 frictionally engages the writing implement, allowing a writer to write when the candy attachment 10 is attached to the writing implement.

The candy attachment of the present invention could be sold in a plastic or other type of wrapper. After purchasing the candy attachment, a user can remove same from the wrapper, and insert the end of a pen or pencil into the sleeve of the candy attachment. After the candy has been consumed, the sleeve can be removed from the writing implement and discarded, and another candy attachment according to the present invention can be provided for attachment to the writing implement.

The shape and configuration of the sleeve of the present invention could be altered as desired without departing from the spirit or scope of the present invention. For example, the sleeve could be widened so that a user's finger can be inserted into the sleeve, so as to provide a “finger lollipop.” The sleeve can be fabricated from a plastic material, or any other suitable material. It is desirable that the sleeve have some elasticity to it to facilitate a frictional fit with a writing implement. The inner surface of the sleeve could also include inner convolutions (or ribs) for engaging the writing implement, as well as outer convolutions on the outer surface of the sleeve for engaging a candy.

It will be understood that the embodiments of the present invention described herein are merely exemplary and that a person skilled in the art may make many variations and modifications without departing from the spirit and scope of the invention. All such variations and modifications, including those discussed above, are intended to be included within the scope of the invention as defined in the appended claims.

What is claimed is:

1. A candy attachment for use with a writing implement comprising a sleeve at least partially embedded within a candy, the sleeve sized and shaped to receive an end of a writing implement and frictionally engaging a writing implement to removably attach the candy to a writing implement.

2. The candy attachment of claim 1, wherein the sleeve is tapered from an aperture at a first end of the sleeve to a second end of the sleeve for receiving a writing implement.

3. The candy attachment of claim 2, wherein the sleeve further comprises a rounded apex at the second end of the sleeve.

4. The candy attachment of claim 2, wherein the sleeve further comprises a rim attached circumferentially about the first end of the sleeve.

5. The candy attachment of claim 1, wherein the sleeve further comprises one or more ribs extending circumferentially about the sleeve between the first and second ends.

6. The candy attachment of claim 2, wherein the sleeve includes a plurality of diameters for accommodating writing implements of different sizes.

7. The candy attachment of claim 6, wherein the sleeve includes a rounded, necked-down area for frictionally engaging an eraser on a pencil.

8. The candy attachment of claim 1, wherein the sleeve is generally cylindrical in shape.

9. The candy attachment of claim 1, wherein the sleeve further comprises inner convolutions for frictionally engaging a writing implement.

10. The candy attachment of claim 9, wherein the sleeve further includes outer convolutions for frictionally engaging the candy.

11. The candy attachment of claim 1, wherein the sleeve is manufactured from a plastic material.

12. A method for consuming candy, comprising:
purchasing a candy attachment having a sleeve at least partially embedded in a candy;
inserting an end of a writing implement into the sleeve to attach the candy attachment to the writing implement; and
consuming the candy.

13. The method of claim 12, further comprising removing the sleeve from the writing implement and discarding the sleeve after the candy has been consumed.

14. The method of claim 13, further comprising purchasing a second candy attachment and attaching the second attachment to a writing implement.

15. A method for providing candy, comprising:
embedding a sleeve at least partially in a candy to form a candy attachment, the sleeve sized and shaped to receive an end of a writing implement; and
packaging the candy attachment.

16. The method of claim 15, further comprising selling the candy attachment.

17. The method of claim 15, further comprising inserting an end of a writing implement into the sleeve prior to packaging the candy attachment.

18. The method of claim 17, further comprising selling the candy attachment and the writing implement.

19. The method of claim 15, wherein the step of packaging the candy attachment comprises wrapping the candy attachment with a plastic wrapper.
